(19) United States
(12) Patent Application Publication
(10) Pub. No.: US 2023/0421385 A1
(43) Pub. Date: Dec. 28, 2023

(54) AN APPARATUS AND METHOD FOR MANAGING THE PROVISIONING OF SECURITY MODULES

(71) Applicant: Kigen (UK) Limited, Cambridge, Cambridgeshire (GB)

(72) Inventor: Patrick BIGET, Courbevoie (FR)

(21) Appl. No.: 18/247,775

(22) PCT Filed: Sep. 15, 2021
(86) PCT No.: PCT/EP2021/075305

§ 371 Date: Apr. 4, 2023

(30) Foreign Application Priority Data
Oct. 22, 2020 (EP) 20306258.3
Feb. 22, 2021 (GB) 2102468.2

(51) Int. Cl. H04L 9/32

(52) U.S. Cl. CPC H04L 9/3247; H04L 9/3234

(57) ABSTRACT

A method of managing the provisioning of security modules is provided, each security module being formed by a chip with at least one subscription profile installed thereon. The method comprises providing a plurality of chips, each chip having a unique chip identifier for that chip and having stored thereon a group key that is common to the plurality of chips, and generating a plurality of data files, each data file having a unique data file identifier for that data file and providing data for an associated subscription profile including an initial network authentication key for the associated subscription profile. Each of the data files is encrypted with the group key. For each data file in the plurality of data files the method further comprises: receiving the encrypted version of that data file and performing a load operation to load that data file onto a selected chip, during which the encrypted version of that data file is decrypted using the group key as stored on the selected chip; and performing a key transformation operation using security module operating software loaded onto the selected chip to calculate a transformed network authentication key from the initial network authentication key. On successful performance of the load operation and the key transformation operation, the security module operating software generates a proof of loading (PoL) file that is cryptographically signed using a signing key, the PoL file identifying the unique data file identifier for the loaded data file and the unique chip identifier of the chip onto which the loaded data file has been loaded.

### BACKGROUND

The present technique relates to an apparatus and method for managing the provisioning of security modules.

Security modules may be associated with devices in order to control access by those devices to network infrastructure provided by a network operator. The security module may for example be implemented by a Subscriber Identity Module (SIM), which may also be referred to as a Universal Integrated Circuit Card (UICC). Modern security modules may be embedded or integrated within a device, and may be able to store more than one subscription profile, where each subscription profile is associated with a network operator. For example, the security module may be an embedded UICC (eUICC) where the UICC is provided as a chip mounted on the circuit board of a device, or an integrated UICC (iUICC) incorporated as one of the modules within a System-on-Chip (SoC).

The organisation and structure of such security modules may be defined by certain Telecommunications Standards, for example by ETSI, 3GPP and GSMA Standards.

One of the key security requirements in the generation of such security modules is the prevention of duplicate production, i.e. the prevention of producing several security modules with the same mobile network operator (MNO) credentials. This security requirement is regulated by the Security Accreditation Scheme (SAS) under the control of the GSMA. The FS.18 specifications (SAS Consolidated Security Guidelines) state that “Prevention of duplicate production is a fundamental principle of SAS”.

### SUMMARY

In one example arrangement there is provided a method of managing the provisioning of security modules, each security module being formed by a chip with at least one subscription profile installed thereon, the method comprising: providing a plurality of chips, each chip having a unique chip identifier for that chip and having stored thereon a group key that is common to the plurality of chips; generating a plurality of data files, each data file having a unique data file identifier for that data file and providing data for an associated subscription profile including an initial network authentication key for the associated subscription profile; encrypting each of the data files with the group key; for each data file in the plurality of data files: receiving the encrypted version of that data file and performing a load operation in order to load that data file onto a selected chip, during which the encrypted version of that data file is decrypted using the group key as stored on the selected chip; performing a key transformation operation using security module operating software loaded onto the selected chip to calculate a transformed network authentication key from the initial network authentication key; and on successful performance of the load operation and the key transformation operation, employing the security module operating software to generate a proof of loading (PoL) file that is cryptographically signed using a signing key, the PoL file identifying the unique data file identifier for the loaded data file and the unique chip identifier of the chip onto which the loaded data file has been loaded.

In another example arrangement there is provided a system for managing the provisioning of security modules, each security module being formed by a chip with at least one subscription profile installed thereon, the system comprising: a chip manufacturing entity arranged to provide a plurality of chips, where each chip has a unique chip identifier for that chip and has stored thereon a group key that is common to the plurality of chips; a data file generation entity to generate a plurality of data files, where each data file has a unique data file identifier for that data file and provides data for an associated subscription profile including an initial network authentication key for the associated subscription profile, the data file generation entity having encryption circuitry to encrypt each of the data files with the group key; and a loading and assembling entity arranged, for each data file in the plurality of data files: to receive the encrypted version of that data file and perform a load operation in order to load that data file onto a selected chip, during which the encrypted version of that data file is decrypted using the group key as stored on the selected chip; to cause security module operating software loaded onto the selected chip to perform a key transformation operation in order to calculate a transformed network authentication key from the initial network authentication key; and on successful performance of the load operation and the key transformation operation, to cause the security module operating software to generate a proof of loading (PoL) file that is cryptographically signed using a signing key, the PoL file identifying the unique data file identifier for the loaded data file and the unique chip identifier of the chip onto which the loaded data file has been loaded.

In a yet further example arrangement there is provided an apparatus for managing the provisioning of security modules, each security module being formed by a chip with at least one subscription profile installed thereon, the apparatus comprising: processing circuitry to generate a plurality of data files, each data file having a unique data file identifier for that data file and providing data for an associated subscription profile including an initial network authentication key for the associated subscription profile; encryption circuitry to encrypt each of the data files with a group key, the group key being a key that is common to a plurality of chips and is loaded onto those plurality of chips; transmission circuitry to transmit the encrypted version of each data file to a loading entity that is responsible for performing a loading operation in respect of each data file in order to load that data file onto a selected chip, during which the encrypted version of that data file is decrypted using the group key as stored on the selected chip; reception circuitry to receive a proof of loading report containing a number of proof of loading (PoL) files, each PoL file relating to a successfully loaded data file that has also successfully had a key transformation operation applied by security module operating software loaded onto the selected chip in order to calculate a transformed network authentication key from the initial network authentication key; and each PoL file having been generated by the security module operating software to identify the unique data file identifier for the loaded data file and the unique chip identifier of the chip onto which the loaded data file has been loaded, and having been cryptographically signed by the security module operating software using a signing key.

In a still further example arrangement there is provided a system for managing the provisioning of security modules, each security module being formed by a chip with at least one subscription profile installed thereon, the system comprising: means for providing a plurality of chips, where each chip has a unique chip identifier for that chip and has stored thereon a group key that is common to the plurality of chips; means for generating a plurality of data files, where each data file has a unique data file identifier for that data file and provides data for an associated subscription profile including an initial network authentication key for the associated subscription profile; encryption means for encrypting each of the data files with the group key; loading and assembling means arranged, for each data file in the plurality of data files: for receiving the encrypted version of that data file and for performing a load operation in order to load that data file onto a selected chip, during which the encrypted version of that data file is decrypted using the group key as stored on the selected chip; for causing security module operating software loaded onto the selected chip to perform a key transformation operation in order to calculate a transformed network authentication key from the initial network authentication key; and on successful performance of the load operation and the key transformation operation, for causing the security module operating software to generate a proof of loading (PoL) file that is cryptographically signed using a signing key, the PoL file identifying the unique data file identifier for the loaded data file and the unique chip identifier of the chip onto which the loaded data file has been loaded.

### BRIEF DESCRIPTION OF THE DRAWINGS

The present technique will be described further, by way of illustration only, with reference to examples thereof as illustrated in the accompanying drawings, in which:

FIG. 1 is a block diagram of a system in accordance with one example implementation;

FIG. 2 is a block diagram illustrating components provided within a security module in one example arrangement;

FIGS. 3A to 3C provide a flow diagram identifying the sequence of steps performed in order to manage the provisioning of security modules in accordance with one example implementation; and

FIG. 4 schematically illustrates the proof of loading mechanism employed in accordance with the techniques described herein.

### DESCRIPTION OF EXAMPLES

As mentioned earlier, one of the key security requirements in the generation of security modules is the prevention of duplicate production.

MNOs typically order security modules in batches, and issue an input file for each batch containing subscription profile identification information for the subscription profiles to be provided on those security modules. The subscription profile identification information may for example comprise IMSI (International Mobile Subscriber Identity) and/or ICCID (Integrated Circuit Card Identifier) information, and the MNO may specify a range of values for those items of identification information.

The MNO will typically require all of the different values of subscription profile identification information within the identified range (for example all the specified IMSI and ICCID values) to be used, but during the security module production process, a given percentage of the security modules may be defective (this percentage often being referred to as the “yield loss”). A defective security module can cause a “hole” in the sequence of subscription profile identification information, for which a replacement security module needs to be produced using the particular subscription profile identification information that had been associated with the defective security module. Whilst this rework process is relatively straightforward to implement in a traditional SIM manufacturing facility, it causes significant issues when considering embedded or integrated security modules (such security modules also being referred to as eSIMs and iSIMs herein), where the production process is much more distributed.

A so-called “two-step personalisation process” has been defined to tackle the specific constraints of eSIMs and iSIMs. In particular, the personalisation is split into two steps, namely a first step where the hardware is personalised with security credentials (for example chip unique root of trust (RoT) keys), and a second step involving the personalisation of the eSIM or iSIM operating system (OS) credentials (for example network keys).

In order to meet the duplicate prevention requirement, the security credentials must be unique for the hardware, and the eSIM or iSIM OS credentials must be tied to the hardware security credentials. However, for the particular case of iSIM, these personalisation operations may be performed at different times, in different locations, and/or by different entities, and hence any rework process required to deal with the above-mentioned “holes” can generate very significant delays in the manufacturing chain.

The techniques described herein aim to alleviate such issues.

In accordance with the techniques described herein, a method of managing the provisioning of security modules is provided, each security module being formed by a chip with at least one subscription profile installed thereon. The method comprises providing a plurality of chips, each chip having a unique chip identifier for that chip and having stored thereon a group key that is common to the plurality of chips. The method also includes generating a plurality of data files, each data file having a unique data file identifier for that data file and providing data for an associated subscription profile including an initial network authentication key for the associated subscription profile. Each of the data files is encrypted with the group key. For each data file in the plurality of data files, the method further comprises receiving the encrypted version of that data file and performing a load operation to load that data file onto a selected chip, during which the encrypted version of that data file is decrypted using the group key as stored on the selected chip. A key transformation operation is also performed using security module operating software loaded onto the selected chip to calculate a transformed network authentication key from the initial network authentication key. On successful performance of the load operation and the key transformation operation, the method further comprises employing the security module operating software to generate a proof of loading (PoL) file that is cryptographically signed using a signing key, the PoL file identifying the unique data file identifier for the loaded data file and the unique chip identifier of the chip onto which the loaded data file has been loaded.

By employing a group key that is common to the plurality of chips, and then securing the generated data files with the group key, this means that the data files are chip agnostic, and accordingly can be loaded onto any chip having that group key stored thereon. The group key can for example be associated with batches of chips or chips of a particular class or type, and accordingly the data files can be loaded onto any of the chips within the batch or of that particular class or type.

However, as mentioned earlier, it is important to be able to tie a given subscription profile to a specific chip in order to meet the duplicate prevention requirement. This is achieved by causing the security module operating software (which may for example take the form of an eSIM or iSIM operating system (OS)) to perform a key transformation process to calculate a transformed network authentication key from the initial network authentication key specified by the data file. That transformed network authentication key will be used in due course to allow the security module to connect to the network, and can be arranged to be unique to the particular combination of subscription profile and chip on which that subscription profile is loaded. The key transformation operation can take a variety of forms, but in one example implementation is a key derivation operation used to calculate a derived network authentication key using both the initial network authentication key specified by the data file and a value uniquely assigned to the selected chip (such as the unique chip identifier of the chip onto which the data file has been loaded).

Further, by using the security module operating software to generate a cryptographically signed proof of loading file, a trusted entity (such as the entity that generated the data files) can perform a verification/analysis of the loading activities performed, and generate a suitable output file to send to the MNO to identify the relevant dynamic data of each subscription profile (including the transformed network authentication key that is dependent on the chip onto which the data file/associated subscription profile has been loaded).

In one example implementation a single bootstrap subscription profile will be loaded onto a chip at the manufacturing stage, and further profiles may subsequently be loaded later on in the eSIM or iSIM lifecycle. However, in an alternative implementation several profiles could be loaded onto a single chip during the manufacturing stage, with the above described technique still ensuring that each subscription profile is only used once.

The security module operating software can be loaded onto the chips in any suitable manner. For instance that software may be installed on a chip when the group key is stored onto that chip. However, in one example implementation each data file provides the security module operating software, and the security module operating software is loaded onto the selected chip during the loading operation.

In one example implementation, the method further comprises performing an analysis operation on the cryptographically signed PoL file at an entity having access to the signing key, in order to verify, using the signing key, the cryptographically signed PoL file. Hence, the entity that performs the verification of the cryptographically signed PoL file can ensure that it has been generated legitimately, in particular using the signing key that is known to both the security module operating software loaded onto the chip and the entity that is performing the verification process. This can hence ensure that the received PoL file has been generated by a trusted source, and hence can be treated as a legitimate PoL file.

The entity that performs the verification of the cryptographically signed PoL file can take a variety of forms, but will typically be a trusted entity such as the entity that generated the original data files. The manner in which entities are determined to be trusted or not may vary dependent upon implementation, but in one example implementation the earlier-mentioned SAS mechanism is used, and hence a trusted entity will be one that has been SAS accredited. In one particular example implementation, both the entity that creates the original chips, and the entity that generates the data files, and subsequently analyses the PoL files, will be SAS accredited. However, there is no requirement for the entity that loads the data files onto the chips to be SAS accredited, since both the key transformation operation and the PoL file generation operation are arranged to be performed by the security module operating software that has been loaded onto the selected chip and hence does not require the entity loading those files onto the chips to itself be SAS accredited.

In one example implementation, the entity having access to the signing key is arranged to receive a PoL report containing the cryptographically signed PoL files for each of the plurality of data files, and performance of the analysis operation further comprises checking that each data file has been used.

Hence, once the generated plurality of data files have been successfully loaded onto chips, and the earlier-mentioned key transformation operations have been performed, a PoL report can be generated containing the various cryptographically signed PoL files for each of the loaded data files, and the entity performing the analysis operation can then perform additional checks over and above verifying that each cryptographically signed PoL file has been generated using the correct signing key. In particular, the entity performing the analysis operation can check that each data file that was generated has in fact been used, and further if desired can check that each data file has only been used once. This can be readily determined from the decrypted PoL files, since as mentioned earlier such PoL files will identify the unique data file identifier for the loaded data file along with the unique chip identifier for the chip onto which the loaded data file has been loaded.

As mentioned earlier, on successful completion of the analysis operation, the method may further comprise generating an output file that in one example implementation may be provided to the MNO that supplied a corresponding input file used to generate the plurality of data files. The output file can identify various dynamic data relevant to each subscription profile represented by the loaded data files, and that dynamic data can be arranged to include, amongst other things, the transformed network authentication key for each subscription profile, i.e. the network authentication key produced as a result of the transformation operation executed by the security module operating software during the process of loading the data file onto a specific chip.

In one example implementation, when either the load operation or the key transformation operation fails for a given data file when using a currently selected chip, the method further comprises selecting a different chip and re-performing the load operation and the key transformation operation for the given data file using the selected different chip.

When selecting the different chip, any chip can be selected that has the same group key stored thereon, since as mentioned earlier the use of the group key effectively enables the data files to be chip agnostic, to the extent that they can be loaded onto any of the chips that have that group key stored thereon and are not tied ab initio to a specific chip. However, in due course, once successfully loaded onto a specific chip, and having successfully performed the key transformation operation, it is to be noted that it is then possible to concretely tie a specific data file to a specific chip, for example by using a value uniquely assigned to the specific chip during the process of generating the transformed network authentication key.

As mentioned earlier, when the security module operating software generates a PoL file, it is arranged to cryptographically sign that PoL file using a signing key. The signing key can be any suitable key known to both the security module operating software and the entity that will be performing the analysis of the PoL files. In one particular example implementation, the signing key is the earlier-mentioned group key, but it will be appreciated that there is no requirement for the group key to be used and instead a different key could be used if desired. Further in one example implementation, the signing key may be generated and included in the data file when the data file is created.

With regards to the group key that is both stored on the plurality of chips, and is used to encrypt each of the data files, then that group key can be specified in a variety of ways, and changed at any desired granularity. For example, the group key may be chosen to be specific to a particular batch of chips. Alternatively, a particular group key may be associated with all chips generated of a particular class of chip, such that different group keys are used for different classes of chips. When a generated data file is then encrypted using the group key, it will be understood that that data file can be loaded onto any chip to which that group key relates, whether that be a particular batch of chips or a particular class of chip.

In one example implementation, the generation of the plurality of data files is performed by an entity verified as meeting specified security requirements. In one particular implementation, the specified security requirements are the SAS requirements. Further, in one example implementation, the entity performing the generation of the plurality of data files is also the entity that is subsequently used to perform the analysis operation on the generated PoL files, and hence is responsible for generating the output file that can be returned to the MNO.

However, as mentioned earlier, the loading of the data files onto the chips can be performed by an entity that is not required to meet the specified security requirements. This provides a great deal of flexibility in the security module provisioning process, whilst ensuring conformance to the SAS requirements. In particular, whilst the chips can be constrained to be generated within an SAS accredited environment, and the plurality of data files can also be constrained to be generated within an SAS accredited environment, the task of loading the data files onto the chips can be performed at a wide variety of different locations by a wide variety of different entities. In one example implementation, the loading of the data files onto the chips is performed by a device manufacturer that is provided with the encrypted versions of the data files by the entity that performed the generation of those data files.

Particular examples will now be described with reference to the Figures.

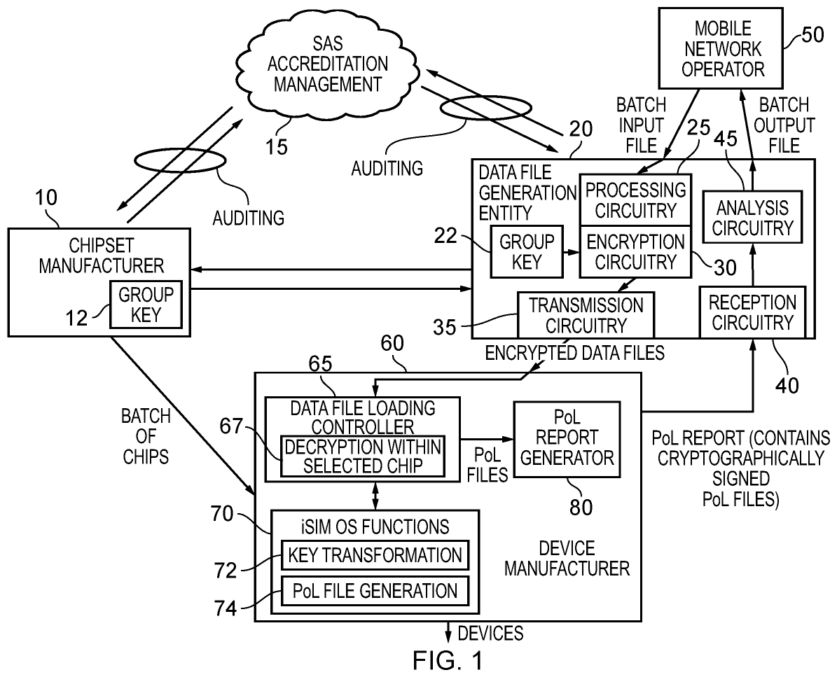

FIG. 1 is a block diagram of a system in accordance with one example implementation. As shown in FIG. 1, a chipset manufacturer 10 can be arranged to generate a batch of chips, with the activities of the chipset manufacturer being SAS accredited. A SAS accreditation management mechanism 15 can be used to ensure conformance with the SAS requirements by the chipset manufacturer 10, and any other entity wishing to be SAS accredited, for example the data generation entity 20. The SAS accreditation management mechanism 15 may be used by the relevant body, for example the GSMA, to perform security audits of each entity wishing to become SAS accredited, and if the security audits are passed the GSMA can be arranged to provide an accreditation to the relevant entity, e.g. the chipset manufacturer 10, typically for a given period of time. This means that this entity is trusted by the GSMA (and therefore all of their MNO members). After that, there is no need for further communication between the SAS accredited entities and the SAS accreditation management, and instead two SAS accredited entities can communicate directly and exchange information in a secure manner (for example the chipset manufacturer 10 and the data generation entity 20) without SAS accreditation management being involved.

Through suitable application of the SAS requirements, the chipset manufacturer can perform personalisation of the chip hardware with security credentials (for example chip unique root of trust (RoT) keys). During the manufacture of the chips, each chip will have a unique chip identifier for that chip stored thereon, and the chipset manufacturer will also store within each of the chips a group key that has been identified for those chips (for example a group key for the particular batch of chips being manufactured, or for the particular class of chips being manufactured). This group key can be stored locally to the chipset manufacture, as indicated by the element 12 in FIG. 1.

As also shown in FIG. 1, a data file generation entity 20 may be provided that is responsible for generating data files representing a batch of subscription profiles. In particular, a mobile network operator (MNO) 50 may provide a batch input file to the data file generation entity 20 that contains subscription profile identification information for a batch of subscription profiles that are to be loading onto security modules. This subscription profile identification information may for example comprise IMSI and/or ICCID information, and the MNO 50 may specify a range of values for those items of identification information.

As noted above the data file generation entity 20 can also be subjected to auditing by the SAS accreditation management mechanism 15 in order to obtain an SAS accreditation. The data file generation entity 20 includes processing circuitry 25 that is arranged to generate data files for each of the specified subscription profiles. When generating the data files, the processing circuitry is arranged to ensure appropriate personalisation of the eSIM or iSIM operating system (OS) credentials (also referred to as the UICC OS credentials) in a manner that conforms to the SAS requirements.

These individual data files can be formed as a binary log of data, and can be arranged to comprise various elements. In particular, each data file may comprise a variety of different profile information that defines each subscription profile. This information may include both a static part, for example information that is specific to the MNO such as roaming agreements, address books, etc., and a dynamic part (this dynamic part often being referred to as the credentials of the subscription profile), the dynamic part containing data that is unique to the particular subscription profile, such as the above-mentioned IMSI and ICCID information, a PIN code, various keys including for example an initial network authentication key (Ki) associated with the specific IMSI, etc. Each data file will also be provided with a unique data file identifier for that data file.

If desired, the data file can also be arranged to include other information, for example the eSIM or iSIM operating system software used to render the SIM functionality on the chip onto which the data file is loaded. Alternatively, this eSIM or iSIM operating software may not be provided in the data file, but instead may be loaded onto the individual chips by the chipset manufacturer at the time the chip is manufactured. For the purposes of the following description, it will be assumed that the eSIM or iSIM OS does form part of each data file generated by the processing circuitry 25.

The various data files generated by the processing circuitry 25 are then encrypted using the encryption circuitry 30, which has access to the same group key that is used by the chipset manufacturer for the group of chips onto which the generated data files are to be loaded. This group key can be stored locally to the data file generation entity 20, as indicated by the element 22. In one example implementation the group key is decided by the chipset manufacturer 10 and securely exchanged with the data generation entity 20.

The encrypted data files as generated by the data file generation entity 20 can then be transmitted by the transmission circuitry 35 to a device manufacturer 60, which is also arranged to receive the batch of chips manufactured by the chipset manufacturer 10. It should be noted that whilst the chipset manufacturer 10 and the data file generation entity 20 are SAS accredited, there is no requirement for the device manufacturer 60 to be so accredited, and instead the techniques described herein can ensure that the individual data files are loaded onto the chips in an appropriate manner to ensure that each data file is used, and is used only once, and thus ensure that the requirement for the prevention of duplicates is ensured even though the loading activity takes place within a non-SAS accredited entity. In particular, the data files are encrypted by the data generation entity and are decrypted inside the chipset, and therefore sensitive data is not exposed at the device manufacturer site.

As will be discussed in more detail later, the device manufacturer can be arranged to seek to load the provided data files onto chips within the batch of chips provided by the chipset manufacturer. In particular, a data file can be selected, a chip can be selected, and then the data file loading controller 65 within the device manufacturer can be used to seek to load the selected data file onto the selected chip. During this operation, a decryption operation 67 can be performed within the tamper-resistant chipset, that uses the group key as stored on the chip to seek to decrypt the encrypted data file. In order for the data file to be successfully decrypted and loaded onto the chip, it is necessary for the group key stored on the chip to match the group key that was used to encrypt the data file at the data file generation entity 20, and if this is not the case the loading operation will fail.

The activities performed by the device manufacturer 60 to seek to load the provided data files onto the provided chips can cause certain eSIM or iSIM OS functions 70 to be activated. In particular, during the loading operation, a key transformation operation 72 can be triggered, whereby the eSIM or iSIM OS performs a key transformation operation on the initial network authentication key specified within the data file. Any suitable key transformation operation can be performed here, but in one example implementation the aim of the key transformation operation is to generate a transformed network authentication key that is specific not only to the particular subscription profile being loaded but also to the chip onto which that subscription profile has been loaded.

In particular, whilst the initial network authentication key can be specified in a way that makes it specific to the associated subscription profile identified by the data file, it is not at the time the data file is generated in any way tied to a particular chip. Indeed, as mentioned earlier, the aim of using the group key approach is to ensure that any of the data files generated for a particular batch of chips can be loaded onto any of those chips, since the same group key will be used, and hence any of the data files can be decrypted using that group key. However, in order to ensure the prevention of duplicates, it is important that the data file can only be used once and this can be ensured by performing the key transformation operation. In particular, when a transformed network authentication key is generated by that key transformation operation, it can then be made specific not only to the subscription profile represented by the data file but also the chip onto which the subscription profile has been loaded, and it is that transformed network authentication key that can then subsequently be used by the MNO when provisioning the eSIM or iSIM onto the network.

The key transformation operation can take a variety of forms, but in one example implementation takes the form of a key derivation operation that is used to calculate a derived network authentication key using both the initial network authentication key and a value that is uniquely assigned to the chip onto which the data file is loaded. This value that is uniquely assigned to that chip can take a variety of forms, but in one example implementation is the unique chip identifier that is associated with the chip at the time it is manufactured by the chipset manufacturer 10.

If either the data loading operation fails, or the key transformation operation fails, then in one example implementation the currently considered chip can be discarded and instead the same data file can be loaded onto another chip from the batch. Once a specific data file has been successfully loaded onto a chip and the key transformation operation has been successfully performed, then another function of the eSIM or iSIM OS can be invoked, namely a PoL file generation function 74. This function employed by the eSIM or iSIM OS generates a PoL file that is cryptographically signed using a signing key known both to the eSIM or iSIM OS and the data file generation entity 20. The PoL file identifies both the unique data file identifier that was allocated to the data file at the time it was generated by the data file generation entity 20, and the unique chip identifier of the chip onto which the loaded data has been loaded, and hence it will be appreciated that the PoL file directly associates a specific data file with a specific chip.

In one example implementation, rather than outputting each PoL file as it is generated, the PoL files are passed to a PoL report generator 80 which waits until a PoL file has been received for every data file in the batch of data files received from the data file generation entity 20, and then collates all of the PoL files into a PoL report that is output back to the data file generation entity 20. In one example implementation this PoL report will contain a cryptographically signed PoL file for each successfully loaded data file.

This PoL report is received by a reception circuitry 40 within the data file generation entity 20 and passed to analysis circuitry 45 for analysis. The analysis performed by the analysis circuitry can take a variety of forms, but may for example include a verification of each PoL file by checking each cryptographically signed PoL file using the signing key. As mentioned earlier, the signing key will be known to the data file generation entity, and can take a variety of forms. In one particular example implementation, the signing key is chosen to be the group key. Hence, the analysis circuitry 45 can ensure that each PoL file in the PoL report has been generated by the eSIM or iSIM OS in the expected manner, and in particular if any PoL file has been generated using a different signing key this will be detected by the analysis circuitry, and an error condition can be flagged.

Assuming the verification of the various cryptographically signed PoL files is successful, the analysis circuitry can also perform some additional checks, in particular checking that each of the generated data files has in fact been used, and further checking that each file has only been used once. Assuming all these checks are passed, then a batch output file can be generated for returning to the MNO 50, this including for each successfully produced eSIM or iSIM (each eSIM or iSIM being a chip onto which at least one data file has been successfully loaded hence specifying at least one subscription profile) certain dynamic data of that eSIM or iSIM. This dynamic data will include the transformed network authentication key generated during the loading process. It is this dynamic data provided in the batch output file that will then be used by the MNO to provision the various eSIMs or iSIMs on to the network.

It should be noted that if any duplicate eSIMs or iSIMs are generated by the device manufacturer, either by accident, or by deliberate action, those duplicates will not be usable. In particular, the key transformation operation 72 will have generated a different transformed network authentication key in respect of the duplicate eSIM or iSIM to the transformed network authentication key that has been generated for the legitimate eSIM or iSIM, and the batch output file will only include the details for the legitimate eSIM or iSIM. Hence, the duplicate eSIM or iSIM will not get provisioned onto the network. This is the case irrespective of whether the duplicate generation is detected by analysis of the PoL report, due for example to the PoL report including more than one PoL file for a particular data file, or even if, through subversive activity, the PoL file generation activity is somehow inhibited for the duplicate eSIM or iSIM. Ultimately, the batch output file will only include, for each subscription profile, one valid set of dynamic data for that subscription profile, and hence only one eSIM or iSIM will be provisioned for any particular subscription profile.

Whilst in FIG. 1 the analysis of the PoL report is performed by the data file generation entity 20, in other implementations a different SAS accredited entity may be tasked with performing that analysis operation.

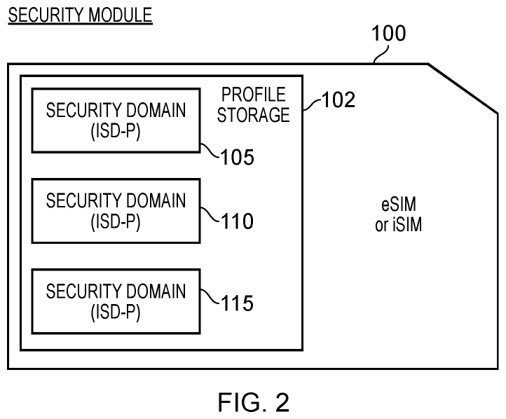

FIG. 2 is a diagram schematically illustrating a security module (eSIM or iSIM) 100. The security module 100 includes profile storage 102 in which to store one or more subscription profiles. In particular, individual security domains 105, 110, 115 can be established within the profile storage 102, where each security domain is used to host an associated subscription profile. The subscription profile of an enabled security domain within the security module is then used to control access via that security module to network infrastructure provided by the network operator with which the subscription profile of that enabled security domain is associated.

During the initial provisioning process described with reference to FIG. 1, it will typically be the case that a single subscription profile will be loaded onto a particular chip, and hence initially only a single security domain 105 may be established within the profile storage 102. However, in an alternative implementation several subscription profiles could be loaded onto a single chip during the provisioning stage, with the above described technique discussed with reference to FIG. 1 still ensuring that each subscription profile is only used once.

Irrespective of whether one, or more than one, subscription profile is loaded onto the chip at the provisioning stage, further subscription profiles may subsequently be loaded onto the security module during the life cycle of that security module.

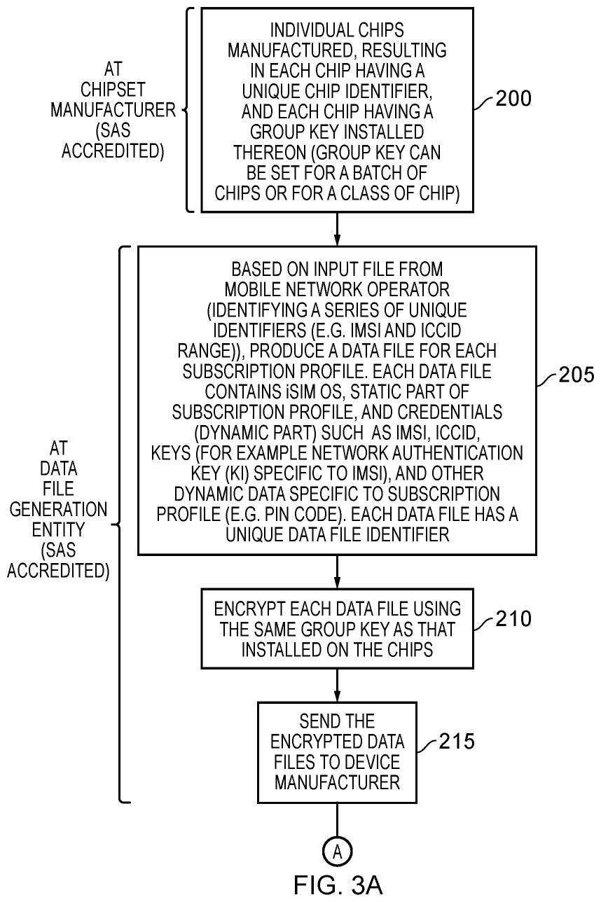

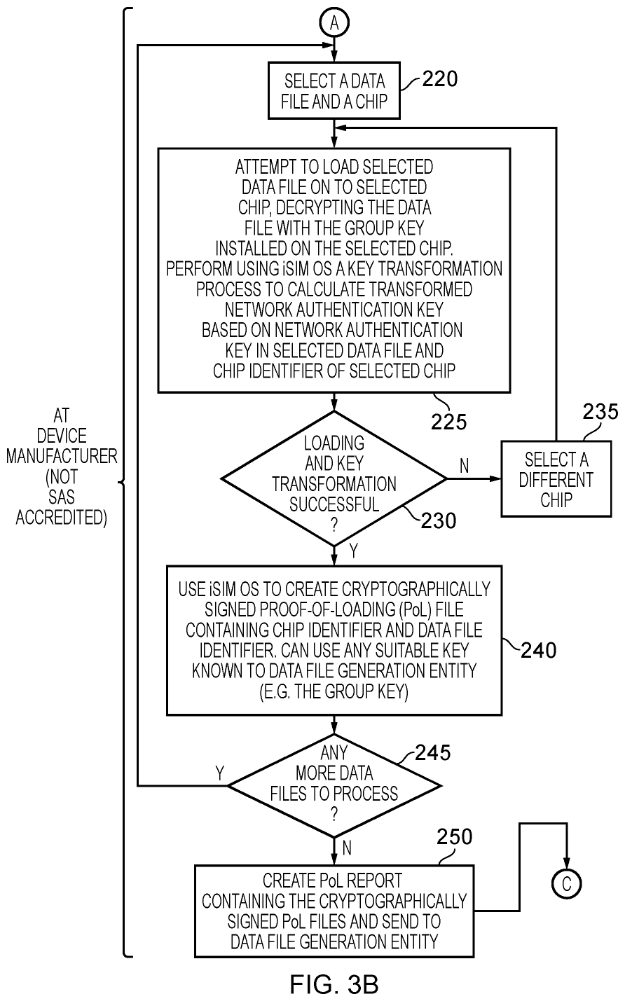

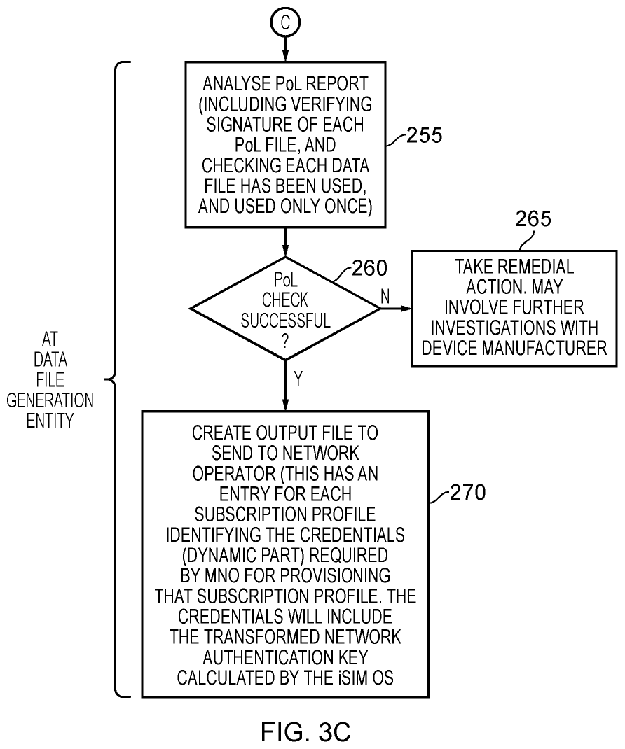

FIGS. 3A to 3C provide a flow diagram identifying a sequence of steps performed in order to manage the provisioning of security modules in accordance with one example implementation. At step 200, a batch of individual chips are manufactured, resulting in each chip having a unique chip identifier, and each chip having a group key installed thereon. The group key can be set in a variety of ways and may be chosen to be specific to a particular batch of chips, or alternatively to be specific to a particular class of chip. As will be appreciated from the earlier discussion of FIG. 1, step 200 may be performed at a chipset manufacturer such as the chipset manufacturer 10 shown in FIG. 1, and in one example implementation that entity is SAS accredited.

At step 205, a data file generation entity will produce a data file for each subscription profile identified by a received input file. In particular, an input file can be received from an MNO identifying a series of unique identifiers for subscriptions, which may be specified for example using ranges of IMSI and ICCID information. Each data file produced will include both a static part of the corresponding subscription profile and a dynamic part (as mentioned earlier this dynamic part also being referred to as the credentials of the subscription profile). The dynamic part may for example include the IMSI and ICCID information, one or more keys such as the network authentication key specific to the IMSI, and any other dynamic data that is specific to the subscription profile, for example a PIN code. Each data file has a unique data file identifier associated with it. As discussed earlier, each data file can also include other information, such as the eSIM or iSIM OS that is to be loaded onto the chip to implement the functionality of the eSIM or iSIM.

At step 210 each produced data file is encrypted using the same group key as that installed on the chips, this group key information being shared between the chipset manufacturer and the data file generation entity. Then, at step 215 the encrypted data files are sent to a device manufacturer. From the earlier discussion of FIG. 1, it will be appreciated that each of steps 205, 210, 215 can be performed by a data file generation entity such as the data file generation entity 20 shown in FIG. 1, and in one example implementation that data file generation entity is SAS accredited.

FIG. 3B then shows a sequence of steps performed at the device manufacturer in order to install the produced data files onto chips produced by the chipset manufacturer. As mentioned earlier, the device manufacturer does not need to be SAS accredited. At step 220, a data file from amongst the provided data files is selected, and also a chip from amongst the batch of chips is selected. Then, at step 225, an attempt is made to load the selected data file onto the selected chip, during which the data file will be decrypted within the selected chip, using the group key that is installed on the selected chip. In addition, assuming the loading operation is successful, the eSIM or iSIM OS loaded onto the chip is then used to perform a key transformation process to calculate a transformed network authentication key from the initial network authentication key. The key transformation process can take a variety of forms but in one example implementation is a key derivation process. In one particular implementation, the transformed network authentication key is calculated based on both the initial network authentication key of the selected data file and the chip identifier of the selected chip.

At step 230 it is determined whether both the loading operation and the key transformation operation were successful, and if not a different chip from amongst the batch of chips provided by the chipset manufacturer is selected at step 235, and the process returns to step 225.

Assuming the loading and key transformation operations were successful, then the process proceeds to step 240 where the eSIM or iSIM OS is used to create a cryptographically signed PoL file containing both the unique chip identifier for the chip onto which the data file has been loaded and the unique data file identifier for the data file that has been loaded. Any suitable key can be used to perform the signing operation, provided it is a key that is known to the data file generation entity, and in one example implementation the group key is used. At step 245 it is determined whether there are any more data files to process within the batch of data files provided by the data file generation entity. If so, the process returns to step 220, but if not the process proceeds to step 250.

At step 250 a PoL report is created that contains the cryptographically signed PoL files for each successfully loaded data file, and that created PoL report is then sent to the data file generation entity.

As shown in FIG. 3C, a sequence of steps are then performed by the data file generation entity based on the received PoL reports. In particular, a step 255 the PoL report is analysed in order to check a number of aspects of the PoL report. This may include for example verifying the signature of each PoL file using the signing key, and then checking that each data file has been used, and has been used only once. At step 260 it is determined whether the PoL check is successful, and if not then at step 265 some remedial action will be taken. This can take a variety of forms depending on implementation, but may involve the data file generation entity undertaking further investigations with the device manufacturer to seek to determine why any issues identified by analysis of the PoL report have arisen.

Assuming the PoL check is successful, then at step 270 an output file is created to send to the network operator. This output file can be generated in the standard manner, and may be arranged to include an entry for each subscription profile identifying the credentials (i.e. the dynamic part) of that subscription profile that will be required by the MNO in order to provision that subscription profile onto the network. The credentials will include the transformed network authentication key calculated by the eSIM or iSIM OS at the time a particular data file was loaded onto a particular chip.

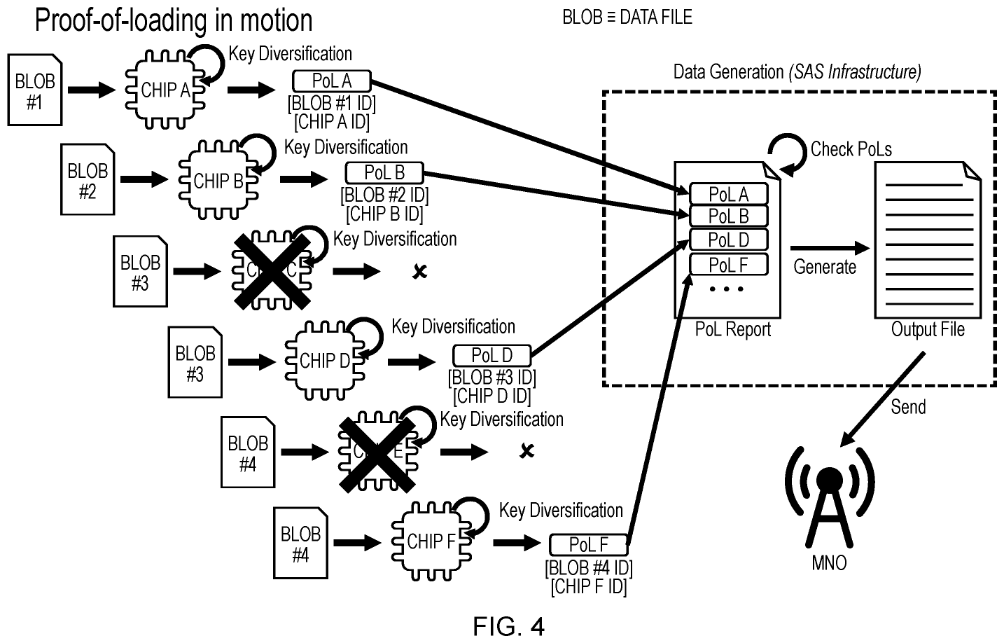

FIG. 4 schematically illustrates the above described proof of loading mechanism. In FIG. 4, the term “blob” is an acronym for binary log of data, and each blob is hence an instance of the earlier-described data file. As shown in FIG. 4, blob number 1 is loaded onto chip A, and a key diversification process is performed in order to generate an updated network authentication key using the key transformation functionality of the eSIM or iSIM OS loaded onto the chip. Assuming successful completion of both the loading and key diversification process, then a PoL file, referred to as PoL A in FIG. 4, is produced identifying both the unique identifier of the blob and the unique identifier of the chip. This PoL file is encrypted as discussed earlier using a signing key, and can then be included in a PoL report provided back to the data generation entity.

As shown in FIG. 4, this process can be repeated for each individual blob, and in the event of a failure to load a particular blob onto a particular chip, such as shown in the example of FIG. 4 when attempting to load blob number 3 onto chip C, then the relevant chip can be discarded and the same blob can be loaded onto a different chip (as shown in FIG. 4 by the example of blob number 3 being loaded onto chip D). Similarly, as shown in FIG. 4, it is assumed that a failure occurs when an attempt is made to load blob number 4 onto chip E, but subsequently blob 4 is successfully loaded onto a different chip (chip F).

Once all of the blobs have been successfully loaded onto a chip, then the various generated PoL files can be collated into a PoL report that is provided back to the data generation entity that is part of the SAS infrastructure. The various PoL files within that PoL report can then be checked, and assuming all the checks are passed, an output file can be generated for sending back to the mobile network operator.

By adopting the techniques described herein, this enables the duplicate prevention requirement when producing security modules such as eSIMs or iSIMs to be met in an efficient manner, despite the fact that the personalisation processes performed in respect of the hardware and the OS credentials are performed at different times, in different locations, and/or by different entities. In particular, the technique described herein significantly improves the efficiency of the rework process required to deal with the earlier-mentioned “holes” that may occur during the eSIM or iSIM generation process, in particular enabling a very significant reduction in any delays in the manufacturing chain. The techniques described herein allow the data files generated not to be tied to a specific chip at the time those data files are generated, due to the use of the group key, but still ensures that individual subscription profiles are tied to individual chips during the loading process so as to ensure that duplication is prevented.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A method of managing the provisioning of security modules, each security module being formed by a chip with at least one subscription profile installed thereon, the method comprising:
providing a plurality of chips, each chip having a unique chip identifier for that chip and having stored thereon a group key that is common to the plurality of chips;
receiving a plurality of data files, each data file encrypted with the group key, each data file having a unique data file identifier for that data file and providing data for an associated subscription profile;
for each data file in the plurality of data files:
performing a load operation in order to load that data file onto a selected chip, during which the encrypted version of that data file is decrypted using the group key as stored on the selected chip;
on successful performance of the load operation, employing the security module operating software to generate a proof of loading (PoL) file that is cryptographically signed using a signing key, the PoL file identifying the unique data file identifier for the loaded data file and the unique chip identifier of the chip onto which the loaded data file has been loaded.

2. A method as claimed in claim 1, further comprising:
performing an analysis operation on the cryptographically signed PoL file at an entity having access to the signing key, in order to verify, using the signing key, the cryptographically signed PoL file.

3. A method as claimed in claim 2, wherein the entity having access to the signing key is arranged to receive a PoL report containing the cryptographically signed PoL files for each of the plurality of data files, and performance of the analysis operation further comprises checking that each data file has been used.

4. A method as claimed in claim 2, further comprising, on successful completion of the analysis operation, generating an output file identifying, for each loaded data file, dynamic data of the associated subscription profile.

5. A method as claimed in claim 1, wherein when the load operation fails for a given data file when using a currently selected chip, the method further comprises selecting a different chip and re-performing the load operation for the given data file using the selected different chip.

6. A method as claimed in claim 1, wherein the signing key is the group key.

7. A method as claimed in claim 1, wherein the signing key is generated and included in the data file when the data file is created.

8. A method as claimed in claim 1, wherein the group key is selected to be common to one of:
a particular batch of chips;
chips within a particular class of chip.

9. A method as claimed in claim 1, comprising generating the plurality of data files, wherein the generation of the plurality of data files is performed by an entity verified as meeting specified security requirements.

10. A method as claimed in claim 1, further comprising:
generating the plurality of data files; and
performing an analysis operation on the cryptographically signed PoL file at an entity having access to the signing key, in order to verify, using the signing key, the cryptographically signed PoL file;
wherein the generation of the plurality of data files is performed by an entity verified as meeting specified security requirements,
wherein the entity performing the generation of the plurality of data files is also the entity performing the analysis operation.

11. A method as claimed in claim 9, wherein the loading of the data files onto the chips is performed by an entity that is not required to meet the specified security requirements.

12. A method as claimed in claim 11, wherein the loading of the data files onto the chips is performed by a device manufacturer that is provided with the encrypted versions of the data files by the entity that performed the generation of those data files.

13. A method as claimed in claim 20, wherein the key transformation operation comprises a key derivation operation performed using the security module operating software loaded onto the selected chip to calculate a derived network authentication key using both the initial network authentication key and a value uniquely assigned to the selected chip.

14. A method as claimed in claim 13, wherein the value uniquely assigned to the selected chip is the unique chip identifier of the selected chip.

15. A method as claimed in claim 1, wherein each data file provides the security module operating software, and the security module operating software is loaded onto the selected chip during the loading operation.

16. A method as claimed in claim 1, wherein the security modules are eSIMs or iSIMs.

17. A system configured to perform the method of claim 1.

18. An apparatus for managing the provisioning of security modules, each security module being formed by a chip with at least one subscription profile installed thereon, the apparatus comprising:
processing circuitry to generate a plurality of data files, each data file having a unique data file identifier for that data file and providing data for an associated subscription profile;
encryption circuitry to encrypt each of the data files with a group key, the group key being a key that is common to a plurality of chips and is loaded onto those plurality of chips;
transmission circuitry to transmit the encrypted version of each data file to a loading entity that is responsible for performing a loading operation in respect of each data file in order to load that data file onto a selected chip, during which the encrypted version of that data file is decrypted using the group key as stored on the selected chip;
reception circuitry to receive a proof of loading report containing a number of proof of loading (PoL) files, each PoL file relating to a successfully loaded data file; and
each PoL file having been generated by the security module operating software to identify the unique data file identifier for the loaded data file and the unique chip identifier of the chip onto which the loaded data file has been loaded, and having been cryptographically signed using a signing key by security module operating software loaded onto the selected chip.

19. A system for managing the provisioning of security modules, each security module being formed by a chip with at least one subscription profile installed thereon, the system comprising:
a chip manufacturing entity arranged to provide a plurality of chips, where each chip has a unique chip identifier for that chip and has stored thereon a group key that is common to the plurality of chips;
a data file generation entity to generate a plurality of data files, where each data file has a unique data file identifier for that data file and provides data for an associated subscription profile, the data file generation entity having encryption circuitry to encrypt each of the data files with the group key; and
a loading and assembling entity arranged, for each data file in the plurality of data files:
to receive the encrypted version of that data file and perform a load operation in order to load that data file onto a selected chip, during which the encrypted version of that data file is decrypted using the group key as stored on the selected chip;
on successful performance of the load operation and the key transformation operation, to cause the security module operating software to generate a proof of loading (PoL) file that is cryptographically signed using a signing key, the PoL file identifying the unique data file identifier for the loaded data file and the unique chip identifier of the chip onto which the loaded data file has been loaded.

20. A method as claimed in claim 1 comprising,
generating the plurality of data files, each data file providing data for the associated subscription profile including an initial network authentication key for the associated subscription profile; and
for each data file in the plurality of data files:
performing a key transformation operation using security module operating software loaded onto the selected chip to calculate a transformed network authentication key from the initial network authentication key; and
on successful performance of the load operation and the key transformation operation, employing the security module operating software to generate the proof of loading (PoL) file that is cryptographically signed using the signing key, the PoL file identifying the unique data file identifier for the loaded data file and the unique chip identifier of the chip onto which the loaded data file has been loaded.
